(19) United States
(12) Patent Application Publication
(10) Pub. No.: US 2025/0172710 A1
(43) Pub. Date: May 29, 2025

(54) VACUUM SYSTEM AND DETECTION DEVICE

(71) Applicant: Forschungszentrum Jülich GmbH, Jülich (DE)

(72) Inventors: Mario Koenen, Aachen (DE); Achim Heynen, Mönchengladbach (DE); Jörg Wolters, Düren (DE)

(21) Appl. No.: 18/839,974

(22) PCT Filed: Feb. 10, 2023
(86) PCT No.: PCT/EP2023/053284

§ 371 Date: Aug. 20, 2024

(30) Foreign Application Priority Data
Feb. 24, 2022 (DE) 10 2022 201 924.5

(51) Int. Cl. G01T 3/00; G01T 7/00

(52) U.S. Cl. CPC G01T 3/008; G01T 7/00

(57) ABSTRACT

The invention relates to a vacuum system with a vacuum chamber and a detection device as well as a detection device for a vacuum system. A vacuum system (1) comprises a vacuum chamber (10) with an outer wall (12). The outer wall encloses a volume (15) which can be evacuated. The vacuum system (1) further comprises a detection device (20) with a detection element for detecting waves and/or particles. The detection device (20) is arranged outside the vacuum chamber (10). In this way, high-quality detection can be achieved with little technical effort.

The invention relates to a vacuum system with a vacuum chamber and a detection device as well as a detection device for a vacuum system.

Detection devices with detection elements for detecting waves and/or particles are used to detect waves or particles. A detection element is an object that interacts with waves and/or particles and thus enables the waves and/or particles to be detected. The detection element may comprise a solid or a liquid, for example in the case of a scintillator. The detection element may comprise a gas container in which a gas or gas mixture for detecting the waves or particles can be arranged. There is a vacuum chamber through which the waves or particles to be detected can reach the detection device without interference.

For example, vacuum systems such as the SEQUOIA instrument at the SNS beam source in the USA, the LET instrument at the ISIS beam source in the UK, the NEAT instrument at the HZB in Berlin or the T-REX instrument currently under construction at the ESS in Sweden are known for detecting neutrons. These include a vacuum chamber and a detection device with a gas container for receiving a gas or gas mixture for the detection of neutrons. A sample can be placed in the vacuum chamber. Neutrons from a neutron source fly to the sample and from there through the vacuum to the detection device, which is located in the vacuum chamber. A sample environment and/or a gate valve (sealing container) may be present.

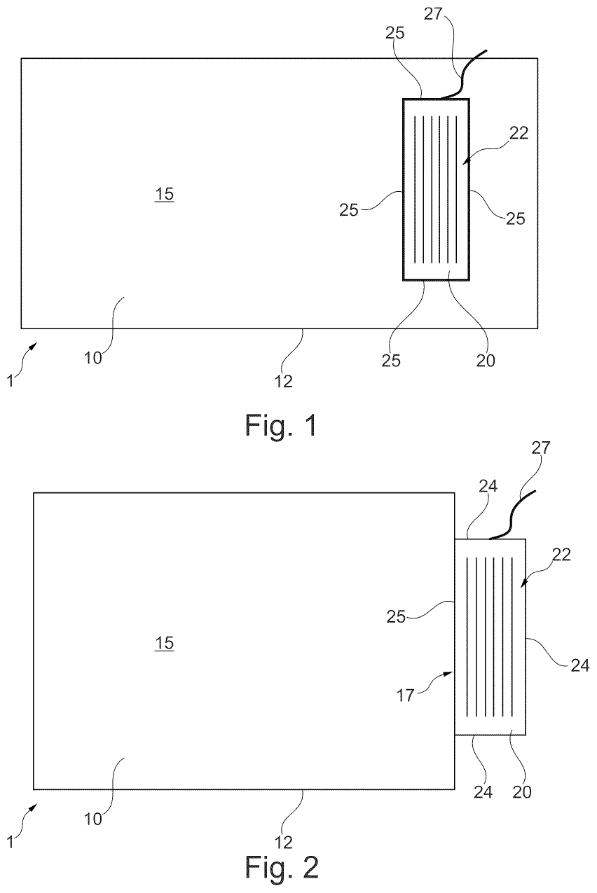

FIG. 1 schematically shows a conventional vacuum system 1 with a vacuum chamber 10, which is bounded by an outer wall 12. Inside the vacuum chamber 10 there is a detection device 20 with a detection element which includes one or more gas containers 22. The emitted and/or scattered or deflected waves or particles pass through the vacuum chamber 10 into the interior of the gas container 22 of the detection device. The gas or gas mixture in the gas containers 22 interacts with the emitted waves or particles in order to detect them. The outer wall 12 of the detection device 20 is designed on all schematically shown sides 25 in such a way that it mechanically withstands the vacuum. The outer wall 12 of the detection device 20 can also be the wall delimiting the gas container 22.

A cable (line) package 27 runs from the detection device 22 through the volume 15 to be evacuated and crosses the outer wall 12 of the vacuum chamber 10. In this way, for example, signals and/or a cooling medium can be exchanged between the detection device 20 and the environment located outside the vacuum chamber 10. Not shown, but usually nevertheless present inside the vacuum chamber 10, is a sample environment in which a sample can be positioned in order to emit waves and/or particles. More precisely, the sample scatters and/or deflects the waves and/or particles after it has been bombarded or irradiated with them. Emitting therefore also means emission in which existing waves and/or particles are merely scattered and/or deflected. This may be the case, for example, when neutrons are used and detected.

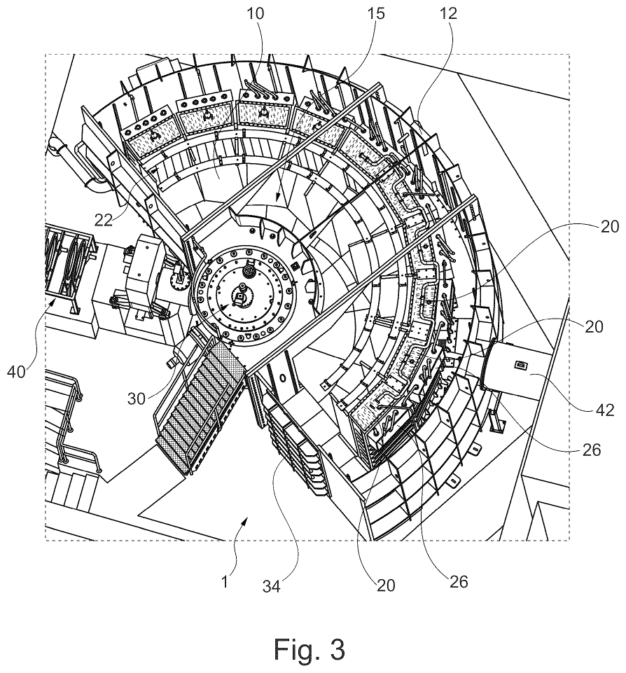

FIG. 3 shows a perspective view of a conventional vacuum system 1 with a vacuum chamber 10 that includes a volume 15 to be evacuated that is bounded by an outer wall 12. Ten detection devices 20 are arranged in the vacuum chamber 10. Each of the detection devices 20 comprises a gas container 22 and a processing unit 26. The respective processing units 26 are connected to the environment outside the vacuum chamber 10 via corresponding vacuum-resistant lines.

Furthermore, parts of a beam conditioning device 40, a beam stop 42 arranged opposite the beam conditioning device 40 for intercepting the primary beams and the sample environment 30 located in the beam path are shown. There is also a door 34 through which users can enter the vacuum chamber 10, for example for maintenance of the detection devices 20. These vacuum systems are technically complex.

It is the task of the invention to provide a further developed vacuum system and a detection device for such a system. In particular, it is the task of the invention to reduce the technical effort while maintaining a high quality of detection.

A vacuum system according to claim 1 and a detection device for a vacuum system according to the additional claim serve to solve the task. Advantageous embodiments are given in the subclaims.

A vacuum system is used to solve the problem. The vacuum system comprises a vacuum chamber with an outer wall enclosing a volume which can be evacuated. The vacuum system further comprises a detection device with a detection element for detecting waves and/or particles. The detection device is arranged outside the vacuum chamber.

The detection device is much easier to access from the outside. Therefore, the vacuum can be maintained and the vacuum chamber does not need to be opened or entered to access the detection device. This reduces the technical effort. In addition, the volume of the vacuum chamber can be reduced so that the amount of material required for the vacuum system is reduced. In addition, the detection device can be produced with a significantly reduced wall thickness, at least in large parts, as the outer walls do not have to withstand the vacuum, at least for the most part, but only the pressure prevailing outside the vacuum chamber. This reduces the technical complexity and costs.

The vacuum chamber is bounded by the outer wall and is suitable for generating a vacuum. In particular, the outer wall has at least one evacuation opening for connecting a vacuum source. In this way, a vacuum can be generated in the vacuum chamber, i.e., the volume can be evacuated. The evacuation opening is open towards the volume. The evacuation opening runs through the outer wall. The evacuation opening can be connected to a vacuum source, for example a vacuum pump. In this way, the volume can be evacuated. The outer wall may be curved and/or have ribs to increase rigidity. The vacuum system may comprise the vacuum source. The vacuum chamber or its outer wall may be produced from stainless steel or aluminum. The vacuum chamber may have a coating or lining, for example made of cadmium.

The volume can serve to be radiated through by particles and/or waves. The volume can serve to receive a sample. In this case, a sample environment may be present within the volume, in or on which a sample can be positioned. Alternatively, the sample environment can be located in another component adjacent to the volume.

The detection device is a device for detecting waves and/or particles. It includes a detection element that interacts with the waves and/or particles and makes them detectable in this way. The waves and/or particles are typically emitted or deflected by a sample located in a sample environment. In this way, information about the sample and/or the waves and/or particles can be obtained. The detection element includes a material that interacts with the waves and/or particles or is configured to receive such a material. A detection device may have a large number of detection elements. The detection device may be designed as a so-called multi-grid detector. In this case, it comprises a plurality of stretched plates and/or tensioned wires. A detection element may be designed as a scintillator.

In one configuration, the detection device comprises one or more cables for transmitting data to an evaluation unit. Due to the arrangement of the detection device outside the vacuum chamber, the cables do not have to run through the vacuum. This reduces the technical effort.

The vacuum system can interact with a radiation source that can bombard a sample received in the sample environment with radiation so that the sample emits particles and/or waves. For example, the radiation source can generate a beam of neutrons, electrons or protons. The radiation source is typically located outside the vacuum chamber and/or outside any sample receiving module, in particular at a distance of more than 100 meters. The vacuum system may comprise the radiation source.

In one embodiment, the detection device comprises a gas container for receiving a gas or gas mixture.

A gas container is a container for receiving a gas or gas mixture. It can be a permanent receiving in which the gas or gas mixture remains essentially unchanged in terms of mass, pressure and composition over periods of hours to months. Alternatively, temporary or short-term receiving may be meant. In particular, the gas container is essentially hermetic. The gas container is arranged outside the vacuum chamber.

Interactions between particles and/or waves to be detected and gas particles of the detection element can take place inside the detection element, i.e., in this embodiment in the gas or gas mixture. A wire and/or sheet metal may be present inside the detection element. The collisions may trigger particles whose electrical charge is dissipated by the wire and/or the sheet metal and can be localized in this way. The interactions are detected in this way by the detection device.

The gas or gas mixture is used to interact with the waves and/or particles. According to the invention, the detection element can be the gas container into which a gas can be introduced to detect the waves and/or particles. The gas or gas mixture itself does not necessarily have to be arranged in the gas container in order to obtain a vacuum system according to the invention.

This achieves a number of advantages. Firstly, the volume of the vacuum chamber can be significantly reduced, as gas containers are typically very large and are no longer present within the vacuum chamber. The volume reduction that can be achieved in this way can be in the region of 50%, which means that considerably less material is required for the vacuum system than with a conventional design. Furthermore, the tightness of the system is improved. No or significantly less gas can escape from the gas container into the vacuum chamber. With the conventional arrangement of the gas container in the vacuum chamber, gas always escapes from the gas container into the remaining volume of the vacuum chamber, as it is not technically possible to achieve 100% tightness. This disturbs the vacuum, causes gas losses and increases the effort required for evacuation. In contrast, the solution according to the invention significantly reduces the leakage rate and thus increases the quality of the vacuum and/or reduces the pumping effort.

In one embodiment, the detection device is configured to detect neutrons. In this embodiment, the volume is used for the transmission of neutrons. Collisions with gas particles must be prevented to ensure an undisturbed trajectory of the neutrons. The neutrons should therefore move undisturbed (without interference) in order to be subsequently detected at a detection device. This is achieved by the evacuated volume. The detection device comprises the gas container. In particular, detection is based on detecting interactions between the neutrons and gas particles in the gas container. For example, such interactions can generate electrical signals that can be detected in a suitable manner. For example, collisions between the electrically neutral neutrons and particles of the gas or gas mixture trigger charged particles whose electrical charge can then be detected. For example, the electrical charges can be dissipated (discharged) via wires. The position of the collision can be determined via the path of the current. In particular, each wire is read out individually in order to achieve a high spatial resolution in the detection device. There can be more than 1000 wires and/or sheets, i.e., more than 1000 measuring channels, to enable high-resolution detection. The vacuum system may be provided as part of a neutron scattering system and/or for neutron spectroscopy. Alternatively, the detection device may be designed to detect electrons or protons.

In one embodiment, the detection device comprises a processing unit for processing detected signals. The processing unit is arranged outside the vacuum chamber. For example, the processing unit may be configured for processing electrical signals, for example by amplifying and/or forwarding them. The signals can be caused by interactions between neutrons and gas particles in the gas container. The processing unit may include electronic components. The processing unit is arranged outside the vacuum chamber and therefore does not have to be encapsulated.

In particular, the detection device further includes an interface for transmitting the signals to an evaluation unit. This is in particular a wired transmission. However, wireless transmission is also possible in principle.

In one embodiment, the processing unit is coolable by means of a cooling medium. The cooling medium can be gaseous or liquid. It may be a cooling gas or cooling gas mixture such as cooling air. It may be a cooling liquid such as cooling water. In particular, the processing unit includes at least one channel and typically several channels through which the cooling medium can flow. In this way, the processing unit can be cooled by means of the cooling medium. The processing unit may comprise a fan to realize a cooling gas flow.

The detection device may comprise one or more lines for supplying and/or discharging the cooling medium. In conventional systems, the line or lines for supplying and/or discharging the cooling medium run through the vacuum chamber, which is not necessary according to the invention. This means that any impairment of the vacuum can be ruled out and any necessary maintenance is significantly simplified due to the improved accessibility. The technical complexity of the lines is also reduced.

In one configuration, the gas container is directly adjacent to the vacuum chamber.

In one embodiment, the vacuum chamber has at least one opening in the outer wall and the detection device is adjacent to the opening in such a way that at least one section of a wall of the detection device limits the volume of the vacuum chamber.

The detection device comprises a wall. In particular, an outer wall is meant which delimits the detection device towards the outside. Typically, this refers to the wall on one side that delimits the detection device towards this side. The opening of the vacuum chamber is typically a through opening. The detection device is typically arranged in such a way that a region of the wall of the detection device closes the opening. In particular, one side of the detection device closes the opening. In particular, outer regions of the wall are in contact with the outer wall of the vacuum chamber surrounding the opening. In one configuration, the detection device is designed and arranged in such a way that there is only one wall between the volume to be evacuated and the gas or gas mixture. This reduces the attenuation of waves and/or particles to be detected, such as neutrons, and leads to better detection. There can be several gas containers in the region of the opening.

The region of the wall of the detection device that closes the opening is in particular an outer wall of the gas container. In this embodiment, the wall of the detection device can simultaneously serve as the outer wall of the gas container and the outer wall of the vacuum chamber. Only this one side of the gas container now needs to be designed to be vacuum-proof and withstand the vacuum. The other sides, for example five sides, only need to withstand the pressure prevailing at the outside. The wall of the detection device may be produced partially or completely from aluminum.

In particular, a seal is arranged between the edge of the outer wall of the vacuum chamber bounding the opening and the detection device. A seal may be arranged on the detection device and/or on the outer wall of the vacuum chamber. In this way, air can be prevented from entering the vacuum chamber in the evacuated state.

In one embodiment, the detection device is designed and arranged in such a way that it supports the outer wall on an upper side of the vacuum chamber against a force directed downwards caused by the vacuum. In other words, the detection device is designed as a load-bearing wall of the vacuum chamber. It supports the upper side, which is pulled downwards by the vacuum. It thus provides the mechanical stability and/or rigidity of the vacuum chamber. Alternatively or additionally, the detection device can also be designed and arranged in such a way that it supports the outer wall on an underside of the vacuum chamber against an upward force caused by the vacuum and/or that it supports the outer wall on a radially outward-facing shell side of the vacuum chamber against an inward force caused by the vacuum.

In one embodiment, the detection device is mechanically detachably attached to the outer wall of the vacuum chamber. The detection device can therefore be removed, for example to replace the detection device. In particular, non-destructive, reversible detachment is meant. The detachable mechanical fastening may comprise screws, for example. Alternatively or additionally, a holding system, for example comprising one or more mounting brackets, can be arranged. The holding system can hold the detection device at the opening of the vacuum chamber.

In one embodiment, the detection device is constructed in two parts and comprises a wall element and an outer element. The wall element of the detection device is attached to the outer wall or can be attached to it. The outer element of the detection device is mechanically detachably attached to the wall element or can be mechanically detachably attached to it. The wall element is located radially inside and the outer element is located radially outside. The wall element closes the vacuum chamber. The outer element may include the gas container. In this way, the gas container and/or one or more detection elements can be removed, for example for maintenance. This embodiment is particularly advantageous in the case of several detection devices, as a vacuum can be generated even if not all detection devices are present.

In one embodiment, the vacuum system comprises a plurality of detection devices. In particular, the detection devices are arranged on a spherical surface, typically on a circular arc and preferably in a semi-circular shape. In this way, all detection devices are at the same distance from the sample. The detection devices can be of the same design.

In other words, several detection devices are arranged outside the volume. In this way, for example, neutrons can be detected that are emitted from a sample at different angles. Detection devices arranged in a semicircle, for example, can cover a measurement angle of 180°.

In one embodiment, the vacuum chamber is essentially semi-circular. The vacuum chamber has a roughly semi-circular basic shape. Minor deviations from the semi-circular shape are comprised.

In one embodiment, the vacuum chamber has a maximum extension of between 3 m and 20 m. In particular, the maximum extension is between 4 m and 10 m. The maximum extension is measured in plan view along the longest straight line that runs through the vacuum chamber. In the case of a semi-circular vacuum chamber, this can be the diameter of the semi-circle. In particular, the maximum extension is between 5 m and 7 m. The radius can be 3 m, for example. The height can be 2.5 m, for example.

In one embodiment, the vacuum chamber has a maximum extension of between 1 m and 20 m. Typically, the trajectory, for example for neutrons, then has an extension corresponding to half this value, i.e., between 0.5 m and 10 m.

In one embodiment, the vacuum chamber does not include an access through which at least one person can enter the volume. It is true that the vacuum chamber is typically large enough, due to the necessary flight paths, for example, so that one or more people could enter the volume. However, this is no longer necessary due to the detection devices arranged on the outside, meaning that a door or similar can be omitted. In this way, the design effort is significantly reduced. Nevertheless, it cannot be ruled out that a person can enter the volume if a detection device is removed. This can be the case, for example, if the vacuum chamber is initially lined with cadmium.

In one embodiment, the vacuum system further comprises a sample receiving module separate from the vacuum chamber. The sample receiving module has a sample environment for receiving a sample. The sample receiving module is mechanically attached to the vacuum chamber.

In other words, the sample that emits waves or particles is placed in a separate module and not, as in conventional systems, in the vacuum chamber itself. Separate means that the sample receiving module is not integral (in one piece) with the vacuum chamber. In this embodiment, the sample receiving module is located outside the vacuum chamber. In particular, the sample receiving module is mechanically detachably attached to the vacuum chamber. It can be attached to the vacuum chamber, for example, by fastening it to the outer wall of the vacuum chamber. This embodiment enables a modular design in which the sample receiving module can be mechanically detached and, for example, replaced. In this way, different sample receiving modules can be used for different tests. The sample receiving module can therefore also be easily manufactured from a different material than the actual vacuum chamber. For example, the sample receiving module can be produced from aluminium, which cannot be magnetized. The vacuum chamber can be produced from stainless steel, which is less expensive and easier to process. The modularity also enables adaptations to future requirements without having to replace the entire chamber.

In particular, the sample receiving module is arranged such that waves or particles emitted from a sample placed in the sample environment can pass from the sample receiving module into the vacuum chamber to continue from the vacuum chamber to the detection device.

In particular, the sample receiving module includes an outer wall. A seal is typically arranged between the outer wall of the sample receiving module and the outer wall of the vacuum chamber. In this way, air can be prevented from entering the vacuum chamber in the evacuated state. For example, the seal may be an inflatable seal.

In particular, the outer wall of the sample receiving module and/or the outer wall of the vacuum chamber includes an opening, wherein the opening is arranged such that waves or particles emitted by the sample move through the opening in the direction of the detection device. In the case of an opening in the outer wall of the vacuum chamber, the sample receiving module can serve to limit the vacuum chamber in a similar way to the detection device. In the case of two overlapping openings in the outer wall of the sample receiving module and the outer wall of the vacuum chamber, the sample receiving module becomes part of the space to be evacuated. This allows the emitted particles and/or waves to pass freely from the sample receiving module into the vacuum chamber.

The sample receiving module typically includes a sample environment in which a sample that is to emit waves and/or particles can be arranged. In particular, the sample environment includes a sample holder in or on which the sample is positioned. The sample environment is typically configured for conditioning the sample. For example, it can provide a desired temperature and/or a desired magnetic field to which the sample is exposed when it is positioned in the sample holder. For example, the sample environment can be cryogenic or strongly magnetic. Accordingly, the sample receiving module may comprise a cryostat or a strong magnet. The sample holder can be arranged interchangeably in the sample environment.

In one embodiment, the gas container for receiving the gas or gas mixture is closed. In other words, the gas or gas mixture is permanently arranged in the gas container. This is not precluded by the fact that a closable opening may be present through which the gas or gas mixture can be fed into or out of the gas container. In particular, helium-3 can be used as the gas or gas mixture in this configuration. In this case, the detection device is designed as a helium-3 detector. In this case, it typically comprises a plurality of gas containers.

In one embodiment, the gas container for receiving the gas or gas mixture is open. In particular, the gas container is connected to a supply line and/or a discharge line for supplying and/or discharging the gas or gas mixture.

In this embodiment, the gas container serves to temporarily receive the gas or gas mixture. In one configuration, the gas or gas mixture can only flow through the gas container without a significant dwell time being realized in the gas container. In particular, continuous purging takes place.

The supply line is used to feed the gas or gas mixture into the gas container. The discharge line is used to discharge the gas or gas mixture out of the gas container. In particular, the vacuum system further comprises a gas flow unit that generates a gas flow through the supply line, the gas container and the discharge line. In particular, the gas or gas mixture used in this configuration may be a mixture of argon and carbon dioxide.

The detection device may have one or more gas containers. In the case of several gas containers, these can be connected to each other or be present individually. Several gas containers can be directly adjacent to each other or spaced apart. One or more gas containers of the detection device can be filled or filled with gas or a gas mixture that is essentially or exactly at atmospheric pressure. This is independent of the open or closed design of the gas container

A further aspect of the invention is a detection device for a vacuum system. In particular, the detection device is a detection device for a vacuum system according to one of the preceding claims. The detection device comprises a detection element for detecting waves and/or particles. The detection element is in particular a gas container for receiving a gas or gas mixture. The detection device has a wall on at least one side of the detection device which is not configured to be placed in a vacuum. In other words, the wall is dimensioned such that it cannot withstand a vacuum. In particular, the wall is not configured to be placed in a vacuum outside the detection device. The use of the detection device in a vacuum is therefore not intended and/or not possible.

In this context, vacuum means a vacuum that is necessary for the scheduled operation of the vacuum system.

The wall on the side is typically dimensioned to withstand atmospheric pressure, but not a vacuum. This applies in particular to the given gas pressure inside the gas container under the operating conditions of the detection device.

All features, advantages and effects of the vacuum system described at the outset and its parts, in particular the detection device, apply accordingly to this aspect of the invention and vice versa.

The wall is in particular a wall delimiting the gas container. In particular, it is arranged on a first side of the detection device and delimits the detection device on this side. In particular, the wall is dimensioned to be non-vacuum-tight on several, preferably five, sides of the detection device.

The wall may be dimensioned on another side so that it can withstand a vacuum. This side can close an opening in the outer wall of the vacuum chamber. The other five sides, for example, only need to withstand the pressure prevailing outside the vacuum chamber. In particular, this is approximately atmospheric pressure.

In the following, exemplary embodiments of the invention are also explained in more detail with reference to figures. Features of the exemplary embodiments can be combined individually or in a plurality with the claimed objects, unless otherwise indicated. The claimed scopes of protection are not limited to the exemplary embodiments.

The figures show:

FIG. 1: a schematic representation of a conventional vacuum system,

FIG. 2: a schematic representation of a vacuum system according to the invention,

FIG. 3: a perspective view of a conventional vacuum system from above, and

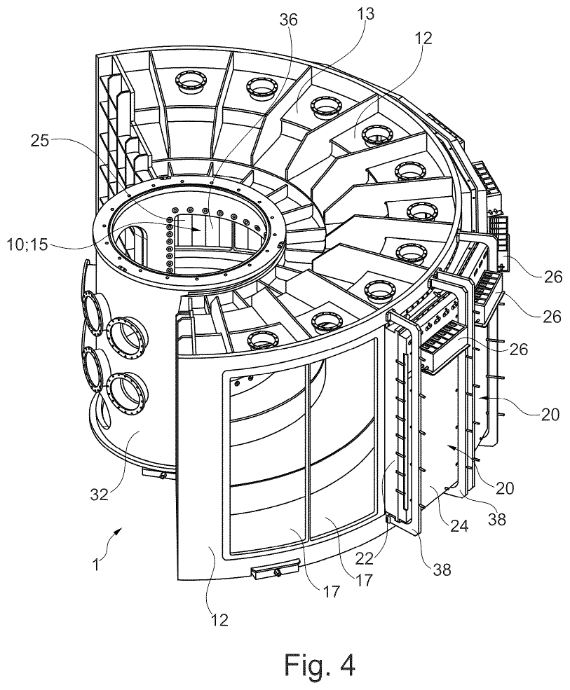

FIG. 4: a perspective view of a vacuum system according to the invention.

FIGS. 1 and 3 have already been discussed in the course of the appreciation of the prior art.

FIG. 2 schematically shows a vacuum system 1 according to the present invention. The vacuum system 1 comprises a vacuum chamber 10 which is bounded by an outer wall 12. A detection device 20 is located outside the vacuum chamber 10. The detection device 20 is directly adjacent to the vacuum chamber 10.

Not shown, but usually nevertheless present the vacuum chamber 10, is a sample environment in which a sample can be positioned in order to emit waves and/or particles. For example, the sample can be bombarded with neutrons for this purpose using a radiation source. The waves or particles emitted in this way, for example neutrons, pass through the vacuum chamber 10 into the interior of the gas container 22 of the detection device. In the figures shown here, the detection element not provided with its own reference sign is the gas container 22. Gas or gas mixture in the gas container 22 interacts with the emitted waves or particles in order to detect them. The vertical lines indicate wires and/or plates which are present in the gas container and which serve to dissipate (discharge) electrical signals from electrically charged particles triggered by collisions. In this way, the neutrons can be detected.

The vacuum chamber 10 has a through opening 17 in the region of the detection device. The outer wall of the detection device 20 is designed on the side 25 shown on the left so that it can mechanically withstand the vacuum. The outer wall of the detection device 20 on the side 25 can at the same time be the wall delimiting the gas container 22 or comprise it. The outer wall 12 of the detection device 20 is not designed to withstand a vacuum on the other sides 24. It is dimensioned correspondingly smaller in terms of its rigidity and the material used. This is possible because only the side 25 shown on the left comes into contact with the vacuum inside the vacuum chamber 10.

A cable package 27 runs away from the detection device 22. The cable package may serve to conduct signals from the detection device 20 to an evaluation device. The cable package may serve to conduct signals from a control unit to the detection device 20. The cable package may serve to conduct a cooling medium to and from the detection device 20. In the region of the detection device 20, the cable package 27 leads in particular to a processing unit of the detection device 20, which serves to process and forward detected signals.

According to the invention, it is not necessary for the cable package 27 to run through the vacuum chamber 10 or to cross the outer wall 12 of the vacuum chamber 10. In this way, the design effort for the cable package 27 can be significantly reduced.

FIG. 4 shows a perspective view of a vacuum system 1 according to the invention with a vacuum chamber 10 which includes a volume 15 to be evacuated which is delimited by an outer wall 12. The vacuum chamber 10 is approximately semicircular in shape. The volume 15 has a maximum extension of 6 m. The maximum extension corresponds to the diameter of the semicircle. In comparison, the conventional vacuum system shown in FIG. 3 requires a maximum extension of the volume of 9 m, wherein the distances between the sample environment 30 and the detection devices 20 of both vacuum systems are the same. Here it becomes clear that the embodiment according to the invention makes it possible to significantly reduce the amount of material used.

The vacuum chamber 10 includes several openings 17 in its outer wall 12. In the exemplary embodiment shown here, the openings 17 are designed as through openings. There are ten through openings, which are arranged evenly distributed over the semi-circular arc, for example.

Detection devices 20 are arranged outside the vacuum chamber 10 and directly adjacent to the outer wall 12 of the vacuum chamber 10. Each detection device 20 covers an opening 17 in the outer wall 12. In this way, a section of the wall of the detection device 20 limits the volume 15 of the vacuum chamber 10. In the exemplary embodiment of the vacuum system 1 shown here, ten detection devices 20 are provided, of which, however, only eight detection devices 20 are shown. In the lower region of the image, two detection devices 20 are omitted for clarity, so that the corresponding openings 17 in the vacuum chamber 10 are visible. These can be used to access the vacuum chamber 10.

In order to evacuate the volume 15, all openings 17 must be closed. Each opening 17 can be closed with a detection device 20. In the configuration shown in FIG. 4, the detection devices are constructed in two parts and include an inner wall element and an outer element. The outer element can be mechanically detached from the wall element. In this way, one or more openings 17 can each be closed with a wall element without the outer element having to be present at the same time. The processing unit 26 is arranged on the outer element.

The detection devices 20 and, in particular, the wall elements are designed as load-bearing elements. They support the outer wall 12 on the upper side 13 of the vacuum chamber 10. The vacuum generates a downward force in the upper side 13, which is at least partially absorbed by the detection devices 20 or the wall elements. In this way, the webs of the outer wall 12 located between the openings 17 can be made smaller. In the same way, the detection devices 20 support the underside downwards and the radial outer walls inwards. In this way, they reinforce the entire construction of the vacuum chamber.

A detection device 20 is typically attached to the outer wall 12 with screws. In addition, one or more mounting (retaining) brackets 38 may be present, which hold the detection device 20 in position and/or press it against the outer wall 12. This is particularly advantageous if the vacuum chamber 10 is not evacuated. As soon as the vacuum chamber 10 is evacuated, the detection devices 20 and/or wall elements are pressed against the outer wall 12 by the atmospheric pressure prevailing outside the vacuum chamber 10 and thus held in position.

Each of the detection devices 20 includes a gas container 22 and a processing unit 26. The functional principle of the detection devices 20 has already been described above. Each detection device 20 also includes a processing unit 26, in which detected signals are processed and/or transmitted to an evaluation unit. Cables for transmitting the data can be connected to the processing unit 26 shown. These do not have to run through the vacuum, as the processing units 26 are easily accessible from the outside.

In particular, the processing unit 26 can be cooled by means of a cooling medium. Due to the external arrangement of the processing unit 26, air cooling can be realized particularly easily by implementing a cooling air flow through the processing unit 26. For example, a fan of the processing unit 26 can be provided for this purpose. Cooling with a liquid cooling medium is also possible. For this purpose, the processing unit may comprise corresponding channels to which suitable lines for the cooling medium can be connected.

In the vacuum system 1 shown here, the sample environment is arranged in the center of a sample receiving module 32 that is separate from the vacuum chamber 10. This is located in the center of the semicircle and is in particular mechanically detachably connected to the vacuum chamber 10. The sample receiving module 32 has a circular cylindrical basic shape and includes an opening 36 in its lateral surface. The opening 36 extends over approximately 180° and overlaps with the semicircular vacuum chamber 10. In this way, emitted waves and/or particles can be detected at an angle of approximately 180°.

In one configuration, the semi-circular vacuum system 1 of FIG. 4 replaces the vacuum system 1 of FIG. 3. Accordingly, the beam conditioning device 40 and/or the beam stop 42 may then also be present in the vacuum system 1 according to the invention. Of course, the door 34 is not necessary in the vacuum system 1 according to the invention also in such a configuration.

### LIST OF REFERENCE SIGNS

Vacuum system 1
Vacuum chamber 10
Outer wall 12
Upper side 13
Volume 15
Opening 17
Detection device 20
Gas container 22
Side 24
Side 25
Processing unit 26
Cable package 27
Sample environment 30
Sample receiving module 32
Door 34
Opening 36
Mounting bracket 38
Beam conditioning device 40
Beam stop 42

1. A vacuum system comprising a vacuum chamber with an outer wall enclosing a volume which can be evacuated, wherein the vacuum system further comprises a detection device with a detection element for detecting waves and/or particles, wherein the detection device is arranged outside the vacuum chamber.

2. The vacuum system of claim 1, wherein detection device comprises a gas container for receiving a gas or gas mixture.

3. The vacuum system of claim 1, wherein the detection device is configured to detect neutrons.

4. The vacuum system of claim 1, wherein the detection device comprises a processing unit for processing detected signals, wherein the processing unit is arranged outside the vacuum chamber.

5. The vacuum system of claim 1, wherein the processing unit is coolable by means of a cooling medium.

6. The vacuum system of claim 1, wherein the vacuum chamber has an opening in the outer wall and the detection device is adjacent to the opening in such a way that at least a section of a wall of the detection device delimits the volume of the vacuum chamber.

7. The vacuum system of claim 6, wherein the detection device is designed and arranged such that it supports the outer wall on an upper side of the vacuum chamber against a downwardly directed force caused by the vacuum.

8. The vacuum system of claim 1, wherein the detection device is mechanically detachably attached to the outer wall of the vacuum chamber.

9. The vacuum system of claim 1, wherein the detection device is constructed in two parts, wherein a wall element of the detection device is attached or attachable to the outer wall and an outer element of the detection device is mechanically detachably attached or attachable to the wall element.

10. The vacuum system of claim 1, wherein the vacuum system comprises a plurality of detection devices, wherein the detection devices are arranged in particular on a circular arc.

11. The vacuum system of claim 1, wherein the vacuum chamber is essentially semicircular in shape.

12. The vacuum system of claim 1, wherein the vacuum chamber has a maximum extension of between 3 m and 20 m, in particular between 4 m and 10 m.

13. The vacuum system of claim 1, wherein the vacuum system further comprises a sample receiving module separate from the vacuum chamber with a sample environment for receiving a sample, wherein the sample receiving module is mechanically attached to the vacuum chamber.

14. The vacuum system of claim 2, wherein the gas container for receiving the gas or gas mixture is closed.

15. The vacuum system of claim 2, wherein the gas container for receiving the gas or gas mixture is open and is connected to a supply line and/or a discharge line.

16. (canceled)

17. The vacuum system of claim 2, wherein the vacuum chamber has an opening in the outer wall and the detection device is adjacent to the opening in such a way that at least a section of a wall of the detection device delimits the volume of the vacuum chamber.

18. The vacuum system of claim 17, wherein the detection device is designed and arranged such that it supports the outer wall on an upper side of the vacuum chamber against a downwardly directed force caused by the vacuum.

19. The vacuum system of claim 1, wherein the vacuum chamber has an opening in the outer wall and the detection device is adjacent to the opening in such a way that at least a section of a wall of the detection device delimits the volume of the vacuum chamber.

20. The vacuum system of claim 6, wherein the detection device is designed and arranged such that it supports the outer wall on an upper side of the vacuum chamber against a downwardly directed force caused by the vacuum.

21. A detection device for a vacuum system, the detection device comprising
a detection element for detecting waves and/or particles, and
a wall at least on one side of the detection device which is not configured to be placed in a vacuum.
